(19) United States
(12) Patent Application Publication
(10) Pub. No.: US 2026/0340893 A1
(43) Pub. Date: Oct. 29, 2026

(54) GENERATION OF SYNTHETIC SEMICONDUCTOR IMAGES

(71) Applicant: Lam Research Corporation, Fremont, CA (US)

(72) Inventors: Yan Kang Lee, Singapore (SG); Kusuma Agusanto, Singapore (SG); Shiva Prasad Mare Gowda, Singapore (SG); Emily Ann Alden, Portland, OR (US)

(21) Appl. No.: 19/115,192

(22) PCT Filed: Sep. 25, 2023
(86) PCT No.: PCT/US2023/075014

§ 371 Date: Mar. 25, 2025

Related U.S. Application Data
(60) Provisional application No. 63/377,150, filed on Sep. 26, 2022.

(51) Int. Cl. G06T 11/60; G06N 3/08; G06T 7/10; G06T 7/60; G06T 11/10

(52) U.S. Cl. CPC G06T 11/60; G06N 3/08; G06T 7/10; G06T 7/60; G06T 11/10; G06T 2207/10024; G06T 2207/10061; G06T 2207/20081; G06T 2207/20084; G06T 2207/30148

(57) ABSTRACT

Methods, systems, and media for generating synthetic semiconductor image data are provided. In some embodiments, a method comprises generating a set of synthetic segmented images, each synthetic segmented image of the set of synthetic segmented images representing a segmented semiconductor metrology image. The method may comprise generating, using a first trained GAN, a set of virtual images, each virtual image corresponding to one of the synthetic segmented images in the set of synthetic segmented images. The method may comprise constructing a training set comprising a plurality of training samples, each training sample comprising a synthetic segmented image from the set of synthetics segmented images and a corresponding virtual image from the set of virtual images, wherein the training set is usable to train a downstream model configured to model semiconductor fabrication processes.

### INCORPORATION BY REFERENCE

A PCT Request Form is filed concurrently with this specification as part of the present application. Each application that the present application claims benefit of or priority to as identified in the concurrently filed PCT Request Form is incorporated by reference herein in its entirety and for all purposes.

### BACKGROUND

Machine learning models, such as neural networks, deep neural networks, etc. may be useful for modeling semiconductor processes. However, such models require large datasets to robustly train the model, which may be difficult to obtain and/or generate.

The background description provided herein is for the purposes of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Systems, methods, and media for generation of synthetic semiconductor images are provided.

In some embodiments, a method for generating synthetic semiconductor image data involves generating a set of synthetic segmented images, each synthetic segmented image of the set of synthetic segmented images representing a segmented semiconductor metrology image. The method involves generating, using a first trained GAN, a set of virtual images, each virtual image corresponding to one of the synthetic segmented images in the set of synthetic segmented images. The method involves constructing a training set comprising a plurality of training samples, each training sample comprising a synthetic segmented image from the set of synthetics segmented images and a corresponding virtual image from the set of virtual images, wherein the training set is usable to train a downstream model configured to model semiconductor fabrication processes.

In some examples, the set of synthetic segmented images are generated using a second trained GAN. In some examples, the first trained GAN and the second trained GAN were trained concurrently. In some examples, training the first trained GAN and the second trained GAN concurrently comprises updating weights associated with a first discriminator and a first generator associated with the first trained GAN based on a discriminator loss and/or a generator loss associated with a second discriminator and/or a second generator associated with the second trained GAN.

In some examples, generating the set of synthetic segmented images comprises generating each synthetic segmented image using a semiconductor process model. In some examples, the semiconductor process model is a model configured to represent a particular semiconductor fabrication process. In some examples, the particular semiconductor fabrication process is an etch process, and wherein the semiconductor process model generates image representing an etch profile as a result of the etch process given a set of process conditions provided as an input to the semiconductor process model. In some examples, the method further involves applying a texture mapping deformation technique to at least one synthetic segmented image of the set of synthetic segmented images generated by the semiconductor process model, and wherein the at least one synthetic segmented image to which the texture mapping deformation technique is applied is included in the set of synthetic segmented images.

In some examples, generating the set of virtual images comprises: generating, from a given synthetic segmented image of the set of synthetic segmented images, a corresponding gray scale image; and providing the corresponding gray scale image to the first trained GAN. In some examples, generating the corresponding gray scale image comprises applying a randomly generated color palette to the given synthetic segmented image.

In some examples, the segmented semiconductor metrology image corresponds to an electron microscopy (EM) image, scanning electron microscopy (SEM) image, a critical-dimension SEM image (CD-SEM), or a transmission electron microscopy (TEM) image.

In some examples, the downstream model trained using the training set is configured to label interfaces between materials in an input image having a same type as the segmented semiconductor metrology image.

In some examples, the downstream model trained using the training set is configured to provide dimension measurements of one or more wafer features included in an input image having a same type as the segmented semiconductor metrology image.

In some examples, the downstream model trained using the training set is configured to provide at least one measurement associated with an interface between materials in an input image having a same type as the segmented semiconductor metrology image.

In some examples, the first trained GAN utilizes a plurality of sets of discriminators and generators, each set of discriminator and generator corresponding to a different layer of a pyramidal structure, and each layer configured to utilize an image of a different size. In some examples, each set of discriminator and generator of the plurality of sets of discriminators and generators are trained sequentially.

According to some embodiments, a computer program product comprising a non-transitory computer readable medium on which is provided computer executable instructions for causing a computational system to perform a method for generating synthetic semiconductor image data is provided. The method involves generating, a set of synthetic segmented images, each synthetic segmented image of the set of synthetic segmented images representing a segmented semiconductor metrology image. The method may involve generating, using a first trained GAN, a set of virtual images, each virtual image corresponding to one of the synthetic segmented images in the set of synthetic segmented images. The method may involve constructing a training set comprising a plurality of training samples, each training sample comprising a synthetic segmented image from the set of synthetics segmented images and a corresponding virtual image from the set of virtual images, wherein the training set is usable to train a downstream model configured to model semiconductor fabrication processes.

In some examples, the set of synthetic segmented images are generated using a second trained GAN. In some examples, the first trained GAN and the second trained GAN were trained concurrently. In some examples, training the first trained GAN and the second trained GAN concurrently comprises updating weights associated with a first discriminator and a first generator associated with the first trained GAN based on a discriminator loss and/or a generator loss associated with a second discriminator and/or a second generator associated with the second trained GAN.

In some examples, generating the set of synthetic segmented images comprises generating each synthetic segmented image using a semiconductor process model. In some examples, the semiconductor process model is a model configured to represent a particular semiconductor fabrication process. In some examples, the particular semiconductor fabrication process is an etch process, and wherein the semiconductor process model generates image representing an etch profile as a result of the etch process given a set of process conditions provided as an input to the semiconductor process model. In some examples, the method further involves applying a texture mapping deformation technique to at least one synthetic segmented image of the set of synthetic segmented images generated by the semiconductor process model, and wherein the at least one synthetic segmented image to which the texture mapping deformation technique is applied is included in the set of synthetic segmented images.

In some examples, generating the set of virtual images comprises: generating, from a given synthetic segmented image of the set of synthetic segmented images, a corresponding gray scale image; and providing the corresponding gray scale image to the first trained GAN. In some examples, generating the corresponding gray scale image comprises applying a randomly generated color palette to the given synthetic segmented image.

In some examples, the segmented semiconductor metrology image corresponds to an electron microscopy (EM) image, scanning electron microscopy (SEM) image, a critical-dimension SEM image (CD-SEM), or a transmission electron microscopy (TEM) image.

In some examples, the downstream model trained using the training set is configured to label interfaces between materials in an input image having a same type as the segmented semiconductor metrology image.

In some examples, the downstream model trained using the training set is configured to provide dimension measurements of one or more wafer features included in an input image having a same type as the segmented semiconductor metrology image.

In some examples, the downstream model trained using the training set is configured to provide at least one measurement associated with an interface between materials in an input image having a same type as the segmented semiconductor metrology image.

In some examples, the first trained GAN utilizes a plurality of sets of discriminators and generators, each set of discriminator and generator corresponding to a different layer of a pyramidal structure, and each layer configured to utilize an image of a different size. In some examples, each set of discriminator and generator of the plurality of sets of discriminators and generators are trained sequentially.

### BRIEF DESCRIPTION OF THE DRAWINGS

FIG. 1 depicts an example system for generation of synthetic semiconductor images in accordance with some embodiments.

FIG. 2 is a diagram of a generative-adversarial network (GAN) that may be utilized in a system for generation of synthetic semiconductor images in accordance with some embodiments.

FIG. 3 is a diagram of an example GAN having a pyramidal structure in accordance with some embodiments.

FIG. 4 is a flowchart of an example process for generating a training set of synthetic semiconductor images in accordance with some embodiments.

FIG. 5 is a flowchart of an example process generating virtual semiconductor images in accordance with some embodiments.

FIG. 6 is a flowchart of an example process for generating synthetic segmented images using a semiconductor process model in accordance with some embodiments.

FIG. 7 presents an example computer system that may be employed to implement certain embodiments described herein.

### DETAILED DESCRIPTION

In the following description, numerous specific details are set forth to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

Disclosed herein are systems, methods, and media for generating synthetic semiconductor image data. In some embodiments, a training set may be generated, where the training set includes multiple (e.g., hundreds or thousands) of training samples. The training samples may include synthetically generated content that is a synthetically-generated version of images or image information acquired using a given semiconductor metrology technique. Example semiconductor metrology techniques include electron microscopy (EM), scanning electron microscopy (SEM), critical dimension SEM (CD-SEM), transmission electron microscopy (TEM), or the like. By way of example, a training sample may include a virtual image that is a synthetically-generated version of an image that may be acquired using a semiconductor metrology technique. In some embodiments, a training sample may include a virtual image (e.g., that is a synthetically-generated version of an image that may be acquired using a given metrology technique), and a corresponding segmented image. The segmented image may include indications of clusters of pixels that have been assigned to a same classification or category, where each classification or category represents a particular wafer feature, material, etc.

By generating a training set that includes synthetically-generated training samples, a training set of hundreds or thousands of training samples may be generated without conducting time and resource-intensive metrology to acquire the training samples. The training set may be used to train one or more downstream models, e.g., which are used to provide measurements associated with interfaces between materials, provide measurements of one or more wafer features, etc. Because the training set of synthetically-generated training samples may be substantially larger than a training set limited to samples acquired using physical metrology techniques (e.g., EM, SEM, CD-SEM, TEM, etc.), the downstream models trained using the training set of synthetically-generated training samples may be trained more quickly (e.g., by converging to a stopping criteria more quickly), and may be more robust (e.g., because a wide data distribution range will be covered in the synthetically generated data sets). Moreover, because the downstream models trained using the training set of synthetically-generated samples are more robust, this may allow semiconductor fabrication processes that rely on the downstream models to operate more efficiently, with higher throughput, fewer discarded wafers, etc.

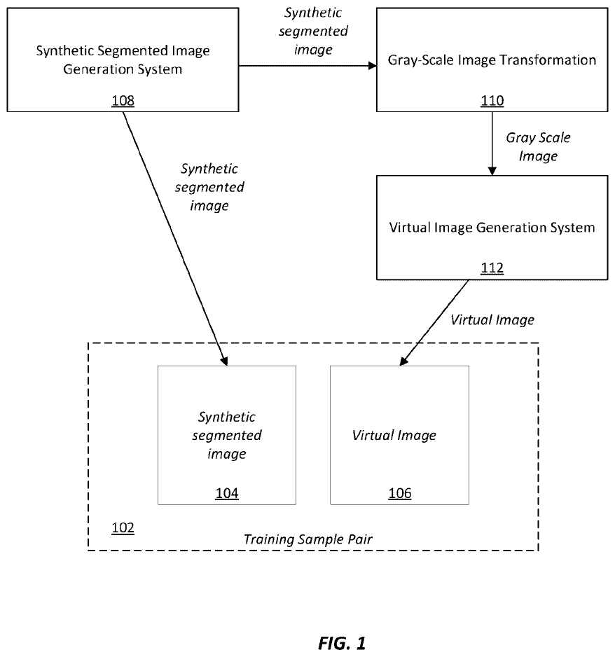

FIG. 1 illustrates an example system for generating synthetic semiconductor images. As illustrated, a training sample pair 102 may be generated. Training sample pair 102 may include a synthetic segmented image 104 and a virtual image 106. As described above, as used herein, a “segmented image” refers to an image in which each pixel has been assigned to a class or category, for example, indicative of a type of material (e.g., interface, fin, etc.) the object corresponding to the pixel is associated with. In other words, a “segmented image” may indicate clusters of pixels that together form an object or element of the image. Conventionally, a synthetic image may be generated using a real image, such as a photograph. In contrast, a “synthetic segmented image,” as used herein, refers to a segmented image generated without any such real image. As used herein, a “virtual image,” is not a real image obtained using imaging techniques, but rather, is a synthetically generated image that appears to have been captured using a particular imaging technique. As described below, a virtual image may be generated using a synthetic segmented image such that the virtual image and the synthetic segmented image used to generate it form a pair. It should be understood that the synthetically generated images are constructed to include similar features, textures, etc. of semiconductor images obtained using a given metrology technique (e.g., SEM, TEM, CD-SEM, etc.), and therefore, the synthetically generated images are both relevant to the semiconductor domain, and are inclusive of a wide range of potential features, textures, etc.

Note that, although FIG. 1 depicts generation of a single training sample pair, which includes one synthetic segmented image (104) and one virtual image (106), in some implementations, a full training set may be generated, where the full training set includes multiple training sample pairs (e.g., one hundred training sample pairs, one thousand training sample pairs, or any other suitable number N).

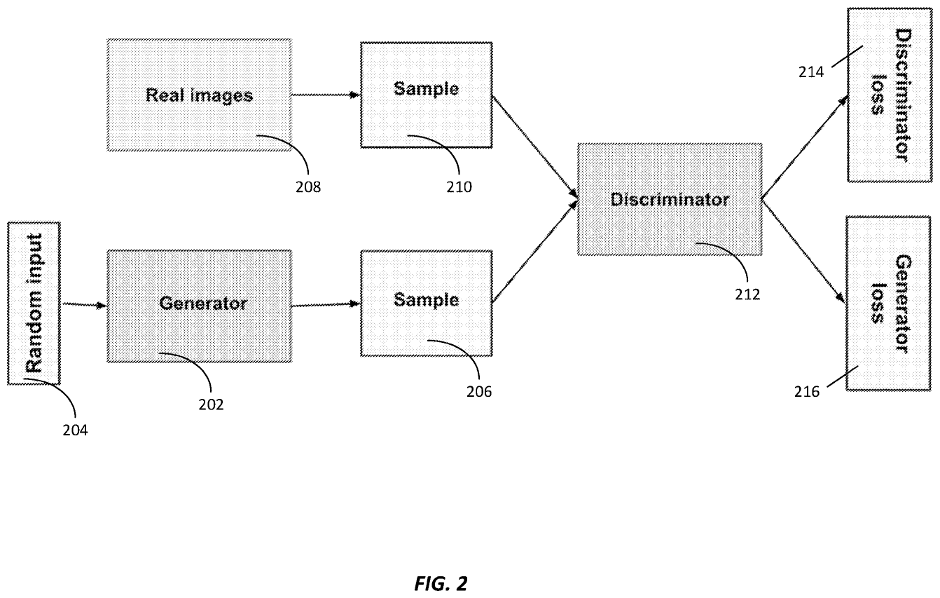

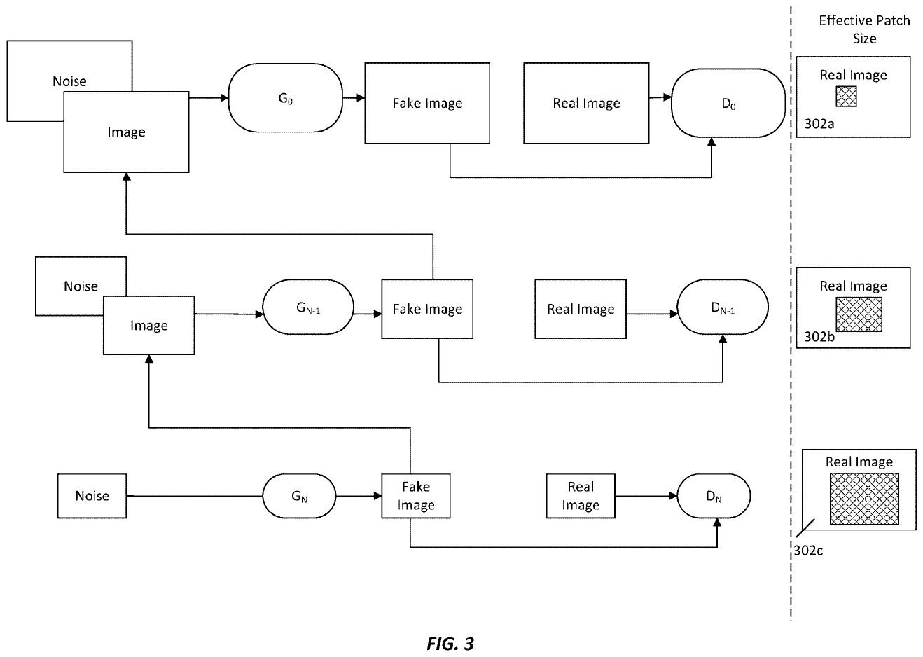

Synthetic segmented image 104 may be generated by a synthetic segmented image generation system 108. In some implementations, synthetic segmented image generation system 108 may include a generative-adversarial network (GAN). Note that architectures for GANs, and training of GANs, are described below in more detail in connection with FIGS. 2 and 3. In some such implementations, the GAN may be trained using one or more segmented images that have been generated using real images acquired using a semiconductor imaging technique. Example imaging techniques include electron microscopy (EM), scanning electron microscopy (SEM), critical-dimension SEM (CD-SEM), transmission electron microscopy (TEM), or the like. The one or more segmented images used to train the GAN may be generated using a machine learning model (e.g., a convolutional neural network, or the like) that has been trained to generate segmented images using a real image as an input. The GAN may take, as an input, a random number seed or random noise image that may be used to control feature dimensions and variations of features in the synthetic segmented images generated by the GAN.

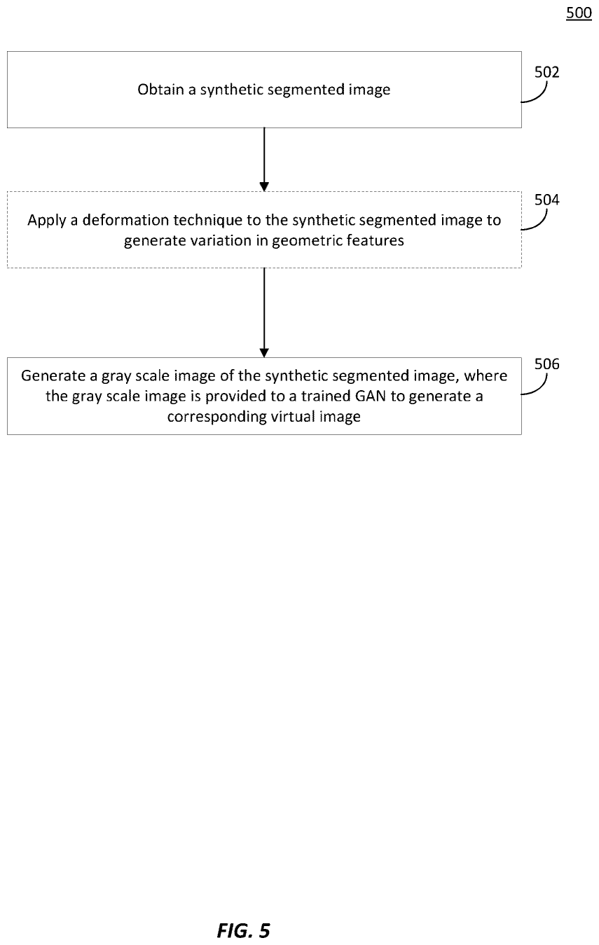

Alternatively, in some implementations, synthetic segmented image generation system 108 may include a semiconductor process model. Such a semiconductor process model may take, as inputs, parameter values corresponding to parameters of a particular fabrication process (e.g., an etch process, a deposition process, etc.) being modeled. The semiconductor process model may generate, as an output, a synthetic segmented image that represents a segmented image of a result of the fabrication process being modeled given the input process parameter values. Note that, as described below in connection with FIG. 5, in some embodiments, various parametric techniques may be applied to the synthetic segmented image to provide variation in features.

Synthetic segmented image 104, generated by synthetic segmented image generation system 108, may be provided to gray-scale image transformation block 110. Gray-scale image transformation block 110 may generate a gray-scale image corresponding to synthetic segmented image 104. More detailed techniques describing generation of a gray scale image from a synthetic segmented image are described below in connection with FIG. 5.

The gray scale image generated by gray-scale image transformation block 110 may then be provided to virtual image generation system 112. Virtual image generation system 112 may be configured to take, as an input, the gray scale version of synthetic segmented image generation system 108, and generate, as an output, a virtual image corresponding to the synthetic segmented image (e.g., virtual image 106).

It should be understood that a training sample pair, which includes a synthetic segmented image and a corresponding virtual image, may be used to train any number of different downstream models. In some embodiments, each downstream model may be a single segmentation model to be used in connection with a particular data set and/or a particular application. In some implementations, using a given trained segmentation model, an image mask may be inferred, from which a number of measurements N may be derived. For example, a downstream model may be trained to label different materials in an input image acquired using the same imaging techniques as that corresponding to the virtual images of the training set. As another example, a downstream model may be trained to provide dimension measurements of one or more wafer features included in an input image acquired using the same imaging technique as that corresponding to the virtual images of the training set using an image mask derived from a downstream model that is itself a trained segmentation model trained using a synthetically generated training set. As yet another example, a downstream model may be trained to provide at least one measurement associated with an interface between materials in an input image acquired using the same imaging techniques as that corresponding to virtual images of the training set. Note that a downstream model may be any suitable type of model, such as a neural network, a deep neural network, a convolutional neural network, etc. By generating a training set that includes synthetic training samples, an arbitrarily large training set may be generated. This may allow for more robust training of a downstream model. Moreover, by using synthetic training data, resource-intensive imaging techniques are not needed to generate each training sample, which may allow for quicker training of downstream models.

As described above in connection with FIG. 1, a synthetic segmented image and/or a virtual image may be generated using a GAN. In general, a GAN is a type of neural network that may be used for unsupervised learning. A GAN may include two neural network models, a discriminator network and a generator network. The generator network may be trained to generate fake samples, while the discriminator network may be trained to discriminate between fake and real samples. Accordingly, by training both the generator network and the discriminator network of the GAN, the GAN may be trained to generate realistic fake (or otherwise referred to as “synthetic”) samples. Note that, while the GAN may be trained by training both the generator network and the discriminator network, at inference time, the GAN may generate realistic synthetic data using the output of the generator network alone. In other words, the discriminator network may be used solely during training, while the trained generator network is used at inference time.

FIG. 2 is a diagram that illustrates the architecture and training of an example GAN. As illustrated, a generator network 202 may take, as an input, a random input 204. Generator network 202 may then generate, as an output, a synthetic (i.e., fake) sample 206. Referring now to discriminator network 212, a real sample 210 may be selected from a set of real samples (e.g., real images 208). Discriminator network 212 may be configured to take, as inputs, real sample 210 and synthetic sample 206 and generate an output indicating which of the two inputs is the real sample. An error associated with the output of discriminator network 212 may then be used to determine discriminator loss 214 and generator loss 216. For example generator loss 216 may be relatively higher in instances in which discriminator network 212 correctly identifies real sample 210 as the real sample, effectively penalizing generator network 202 for not generating a realistic enough synthetic sample. In contrast, discriminator loss 216 may be relatively higher in instances in which discriminator network 212 incorrectly identifies the real sample, effectively penalizing discriminator network 212 for not correctly discriminating between real and synthetic inputs. By concurrently updating generator network 202 and discriminator network 212, generator network 202 may be trained to generate highly realistic synthetic samples. Note that, once training of the GAN has been completed, the trained GAN may include a trained generator network that is now (e.g., after training) configured to generate realistic synthetic samples.

In some implementations, a GAN (e.g., a GAN used to generate synthetic segmented images and/or a GAN used to generate virtual images from a synthetic segmented image) may have a pyramidal structure comprising a set of layers. Using such a pyramidal structure, the GAN may be trained using as few as a single real image. Each layer may include a generator network and a discriminator network. Each layer may operate on a patch of the real image used to train the GAN such that lower level layers operate on patches having lower (e.g., coarser) resolution, and higher level layers operate on patches having higher (e.g., finer) resolution. Accordingly, by training all of the layers of the GAN, the GAN may, in aggregate, learn to synthetically generate both coarse and fine features in synthetic images. In some embodiments, for a given layer of the GAN, the generator network may receive both a random seed image (e.g., noise) having the size corresponding to the patch that layer of the GAN operates on, as well as the synthetically generated image generated by the generator network of the preceding (e.g., lower level) GAN. For a given layer, the discriminator network may receive the synthetically generated image of the generator network from the same layer. In some implementations, generator networks and discriminator networks may be trained sequentially for the different layers for a given image, such that lower level layer networks (corresponding to lower, or coarser resolution) are trained before higher level layer networks (corresponding to higher, or finer resolution). In particular, because higher level layer networks may depend on the output of a generator network of the preceding lower level network, the higher level layer networks may be trained after and/or based on the lower level layer network for a given image. Additionally, it should be noted that, at each layer, the generator network may take as an input, a noise image having the same size as the image generated by the generator network at that layer. At layers other than the lowest level resolution (e.g., the smallest image size), the generator network may take two inputs, corresponding to a noise image and the synthetic image generated by the generator network of the preceding layer. Note that an example of a GAN having a pyramidal structure is the SinGAN network, although other types of GANs having a pyramidal structure may be used.

FIG. 3 shows an example implementation of a GAN having a pyramidal structure according to some embodiments. As illustrated, each layer from 0 to N includes a generator network and a discriminator network. In particular, for a given layer i, the corresponding generator network is represented as Gᵢ, and the corresponding discriminator network is represented as Dᵢ. Layer 0 represents the layer with the highest (e.g., finest) resolution, and layer N represents the layer with the lowest (e.g., coarsest) resolution.

It should be understood that such a pyramidal structure may be used to train a generator network and discriminator network using as few as a single training image. Such training may be performed by sampling various patches of the single training image, where different layers of the pyramidal structure operate on patches having different sizes. FIG. 3 illustrates effective patch sizes 302a, 302b, and 302c, each corresponding to a different layer of the pyramidal structure. As illustrated, smaller patch sizes, which correspond to higher (e.g., finer) resolution, are associated with larger-sized images taken as input by the generator networks and corresponding larger-sized synthetic images generated by the generator network of the layer. Note that the number of layers N may be selected in order to optimally learn the granular features of an image. In some implementations, N may be 3 layers, 4 layers, 5 layers, or the like. By way of example, in an instance in which N=4, image sizes of 1024×1024 pixels at layer 0, 512×512 pixels at layer 1, 256×256 pixels at layer 2, and 128×128 pixels at layer 4 may be used.

Note that, although a GAN, in particular one having a pyramidal structure such as that shown in and described above in connection with FIG. 3, may be trained using as few as a single image, in some implementations, a GAN may be trained with multiple (e.g., two, five, ten, twenty, one hundred, etc.) images. Furthermore, in instances in which synthetic segmented images are generated using a GAN (e.g., rather than using a semiconductor process model or other technique to generate the synthetic segmented image), the synthetic segmented image GAN and the virtual image GAN (which generates a virtual image based on a corresponding synthetic segmented image) may be trained concurrently. Training both GANs concurrently rather than training the synthetic segmented image GAN first and then subsequently training the virtual image GAN may save a substantial amount of time by performing the training of each GAN in parallel.

As described above in connection with FIG. 1, in some implementations, a training set may be constructed that may be used to train a downstream model. The training set may be constructed by generating a set of training samples, where each training sample includes a pair of images. The pair of images may include a synthetic segmented image and a corresponding synthetically generated virtual image. The synthetically generated virtual image may be a synthetic image that appears to be an image acquired using a semiconductor metrology technique, such as EM, SEM, CD-SEM, TEM, or the like. The synthetic segmented image may be generated using a GAN (e.g., using a trained generator network) or a semiconductor process model. The virtual image may be generated based on the synthetic segmented image (e.g., as described below in more detail in connection with FIG. 5). For example, the virtual image may be generated by providing the synthetic segmented image as an input to a GAN (e.g., a GAN as shown in and described above in connection with FIG. 2 and/or in FIG. 3), in particular, as an input to a trained generator network of a GAN.

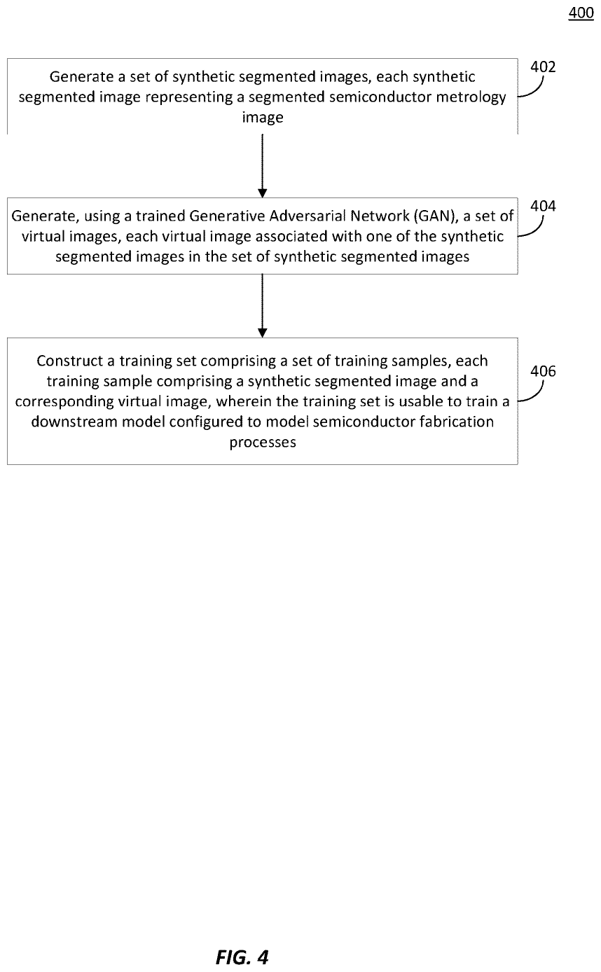

FIG. 4 is a flowchart of an example process 400 for generating a training set in accordance with some embodiments. In some implementations, blocks of process 400 may be implemented by a server device. In some embodiments, blocks of process 400 may be performed in an order other than what is shown in FIG. 4. In some embodiments, two or more blocks of process 400 may be executed substantially in parallel. In some embodiments, one or more blocks of process 400 may be omitted.

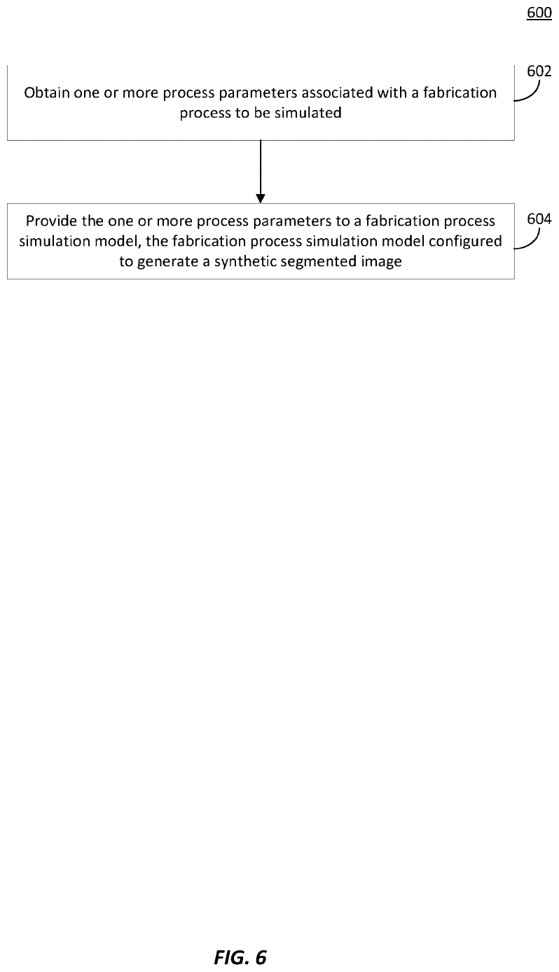

At 402, process 400 may begin by generating a set of synthetic segmented images, each synthetic segmented image representing a segmented semiconductor metrology image. Examples of types of semiconductor metrology include EM, SEM, CD-SEM, TEM, or the like. The synthetic segmented image may include indications of clusters of pixels assigned to the same category, e.g., type of material, wafer feature, etc. In some embodiments, the synthetic segmented image may be generated by a GAN (e.g., by a trained generator network). In some implementations, the GAN may have a pyramidal structure, as shown in and described above in connection with FIG. 3. Alternatively, in some embodiments, the synthetic segmented image may be generated using a semiconductor process model, as shown in and described below in more detail in connection with FIG. 6.

At 404, process 400 can generate, using a GAN (e.g., using a trained generator network), a set of virtual images, each virtual image corresponding to one synthetic segmented image in the set of synthetic segmented images. In other words, for a given pair of synthetic segmented image and corresponding virtual image, the virtual image may be a synthetic image having the texture and features associated with a given semiconductor acquisition technique (e.g., EM, SEM, CD-SEM, TEM, or the like). Continuing with this example, the corresponding synthetic segmented image may be a segmented version of the virtual image, for example, indicating clusters of pixels assigned to the same category (e.g., wafer feature category, material category, etc.).

In some embodiments, each virtual image may be generated by creating a gray scale version of the segmented image. The gray scale version of the segmented image may then be provided to a trained GAN (e.g., to a trained generator network), which is configured to generate, as an output, the virtual image. More detailed techniques for generating virtual images are shown in and described below in connection with FIG. 5.

At 406, process 400 can construct a training set comprising a set of training samples, each training sample comprising a synthetic segmented image and a corresponding virtual image, where the training set is usable to train a downstream model configured to model semiconductor fabrication processes. Note that the training set may additionally include original images (e.g., original images used to generate the synthetic images). For example, as described above in connection with FIG. 1, the training set may be constructed by collating multiple training samples, each including a synthetic segmented image and a corresponding virtual image. The training set may include hundreds or thousands of training samples. Note that, in some embodiments, the training set may include a combination of real images (e.g., acquired using the semiconductor metrology technique) and segmented images constructed based on the real images, as well as synthetic training samples (e.g., a synthetic segmented image and corresponding virtual image). Note that, in some embodiments, all images of the training set may be associated with the same semiconductor metrology technique (e.g., EM, SEM, CD-SEM, TEM, or the like).

As described above in connection with block 404 of FIG. 4, a virtual image may be generated using a GAN and based on a synthetic segmented image. In particular, a gray scale version of the synthetic segmented image may be generated. The gray scale image may be generated by applying a color palette to the synthetic segmented image. The color palette may be a randomly generated color palette. In some embodiments, prior to generating the gray scale version of the synthetic segmented image, a parametric deformation technique may be applied to the synthetic segmented image. The parametric deformation technique may cause variations, such as variability across a set of wafer features, to be introduced in the synthetic segmented image. By applying a parametric deformation technique to the synthetic segmented image, the training set may include a more representative collection of wafer-to-wafer variations, which may in turn allow for more robust training of the downstream model. It should be noted that, in some implementations, parametric deformation techniques may be applied in instances in which a semiconductor process model is used to generate the synthetic segmented image. Examples of parametric deformation techniques that may be used include texture mapping and image deformation.

FIG. 5 is a flowchart of an example process 500 for generating virtual images based on synthetic segmented images in accordance with some embodiments. In some implementations, blocks of process 500 may be executed by a server device. In some embodiments, blocks of process 500 may be executed in an order other than what is shown in FIG. 5. In some embodiments, two or more blocks of process 500 may be executed substantially in parallel. In some embodiments, one or more blocks of process 500 may be omitted.

Process 500 can begin at 502 by obtaining a synthetic segmented image. Similar to what is described above in connection with block 402 of FIG. 4, the synthetic segmented image may include indications of clusters of pixels assigned to the same category, e.g., type of material, wafer feature, etc. In some embodiments, the synthetic segmented image may be generated by a GAN (e.g., by a trained generator network). In some implementations, the GAN may have a pyramidal structure, as shown in and described above in connection with FIG. 3. Alternatively, in some embodiments, the synthetic segmented image may be generating using a semiconductor process model, as shown in and described below in more detail in connection with FIG. 6.

In some embodiments, at 504, process 500 can apply a parametric deformation technique to the synthetic segmented image to generate variation in geometric features. Such variation may include feature-to-feature variations in various wafer dimensions, variations in feature angles or tilts, etc. Examples of parametric deformation techniques include shape deformation. Examples of shape deformation include texture mapping and image deformation. In some embodiments, parametric deformation techniques may be applied to synthetic segmented images generated using a semiconductor process model. In some implementations, block 504 may be omitted.

At 506, process 500 can generate a gray scale image of the synthetic segmented image, where the gray scale image is provided to a trained GAN (e.g., to a trained generator network) to generate a corresponding virtual image. In some embodiments, the gray scale image may be generated by applying a color palette (e.g., a random color palette) to the synthetic segmented image. Note that, in instances in which a parametric deformation technique is applied at block 504, the gray scale image may be generated using the synthetic segmented image after application of the deformation technique. As described above in connection with FIGS. 1 and 4, the gray scale image may be provided as an input to a trained GAN (e.g., to a trained generator network).

As described above in connection with FIGS. 4 and 5, in some implementations, a synthetic segmented image may be generated using a semiconductor fabrication process model. Such a process model may simulate the physical and/or chemical processes that occur during fabrication processes (e.g., etch processes, deposition processes, etc.). The process models may be behavioral models and/or models of surface reactions (e.g., surface kinetic models). In some embodiments, a process model make take, as inputs, process parameter values that represent knobs associated with a semiconductor process to be simulated. The semiconductor process model may then generate, as an output, a synthetic segmented image that represents a processed wafer result of the fabrication process using the given process parameter values.

FIG. 6 is a flowchart of an example process 600 for generating a synthetic segmented image using a semiconductor process model in accordance with some embodiments. In some implementations, blocks of process 600 may be performed on a server device. In such implementations, the server device may be the same as or different than a server device used to implement blocks of processes 400 and/or 500. In some embodiments, blocks of process 600 may be executed in an order other than what is shown in FIG. 6. In some implementations, two or more blocks of process 600 may be executed substantially in parallel. In some implementations, one or more blocks of process 600 may be omitted.

At 602, process 600 can begin by obtaining one or more process parameters associated with a fabrication process to be simulated. The process parameters may include parameters associated with process temperatures, parameters associated with process gases (e.g., gas species, gas mixtures, gas flow rates, gas partial pressures, etc.), parameters associated with plasmas to be used (e.g., plasma power, plasma species, etc.), and/or any other suitable process parameters. The process parameters may be obtained using, e.g., a user interface.

At 604, process 600 can provide the one or more process parameters to a fabrication process simulation model, which is configured to generate, as an output, the synthetic segmented image.

Note that, in some implementations, process 600 may be executed to generate a relatively small number of synthetic segmented images (e.g., one, two, three, etc.). The small number of synthetic segmented images may then be manipulated to generate a larger set of synthetic segmented images, for example, by performing one or more parametric deformation techniques to introduce various plausible feature variations. The larger set of synthetic segmented images may then be used to generate corresponding virtual images. In this way, a relatively computationally-intensive process simulation model (e.g., as used in process 600) may be run relatively few times, and used to generate a much larger synthetic training set, which may then in turn be used to train one or more downstream models.

### CONTEXT FOR DISCLOSED COMPUTATIONAL EMBODIMENTS

Systems including fabrication tools as described herein may include logic for automated control of components.

The analysis logic may be designed and implemented in any of various ways. For example, the logic can be implemented in hardware and/or software. Examples are presented in the controller section herein. Hardware-implemented control logic may be provided in any of a variety of forms, including hard coded logic in digital signal processors, application-specific integrated circuits, and other devices that have algorithms implemented as hardware. Analysis logic may also be implemented as software or firmware instructions configured to be executed on a general-purpose processor. System control software may be provided by “programming” in a computer readable programming language.

The computer program code for controlling processes in a process sequence can be written in any conventional computer readable programming language: for example, assembly language, C, C++, Pascal, Fortran, Python, or others. Compiled object code or script is executed by the processor to perform the tasks identified in the program. Also as indicated, the program code may be hard coded.

Integrated circuits used in logic may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated in the form of various individual settings (or program files), defining operational parameters for carrying out a particular analysis or image analysis application.

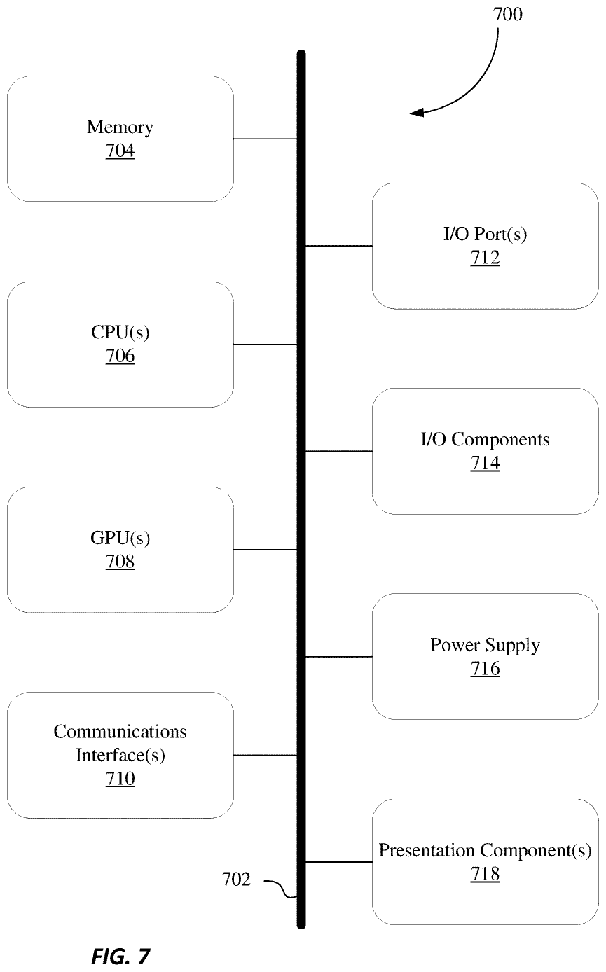

FIG. 7 is a block diagram of an example of the computing device 700 suitable for use in implementing some embodiments of the present disclosure. For example, device 700 may be suitable for implementing some or all functions for generating synthetic segmented images and/or generating synthetic images as described herein.

Computing device 700 may include a bus 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, and one or more presentation components 718 (e.g., display(s)). In addition to CPU 706 and GPU 708, computing device 700 may include additional logic devices that are not shown in FIG. 7, such as but not limited to an image signal processor (ISP), a digital signal processor (DSP), an ASIC, an FPGA, or the like.

Although the various blocks of FIG. 7 are shown as connected via the bus 702 with lines, this is not intended to be limiting and is for clarity only. For example, in some embodiments, a presentation component 718, such as a display device, may be considered an I/O component 714 (e.g., if the display is a touch screen). As another example, CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “electronic control unit (ECU),” “virtual reality system,” and/or other device or system types, as all are contemplated within the scope of the computing device of FIG. 7.

Bus 702 may represent one or more busses, such as an address bus, a data bus, a control bus, or a combination thereof. The bus 702 may include one or more bus types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus.

Memory 704 may include any of a variety of computer-readable media. The computer-readable media may be any available media that can be accessed by the computing device 700. The computer-readable media may include both volatile and nonvolatile media, and removable and non-removable media. By way of example, and not limitation, the computer-readable media may comprise computer-storage media and/or communication media.

The computer-storage media may include both volatile and nonvolatile media and/or removable and non-removable media implemented in any method or technology for storage of information such as computer-readable instructions, data structures, program modules, and/or other data types. For example, memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. As used herein, computer storage media does not comprise signals per se.

The communication media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the communication media may include wired media such as a wired network or direct-wired connection, and wireless media such as acoustic, RF, infrared and other wireless media. Combinations of any of the above should also be included within the scope of computer-readable media.

CPU(s) 706 may be configured to execute the computer-readable instructions to control one or more components of the computing device 700 to perform one or more of the methods and/or processes described herein. CPU(s) 706 may each include one or more cores (e.g., one, two, four, eight, twenty-eight, seventy-two, etc.) that are capable of handling a multitude of software threads simultaneously. CPU(s) 706 may include any type of processor and may include different types of processors depending on the type of computing device 700 implemented (e.g., processors with fewer cores for mobile devices and processors with more cores for servers). For example, depending on the type of computing device 700, the processor may be an ARM processor implemented using Reduced Instruction Set Computing (RISC) or an x86 processor implemented using Complex Instruction Set Computing (CISC). Computing device 700 may include one or more CPUs 706 in addition to one or more microprocessors or supplementary co-processors, such as math co-processors.

GPU(s) 708 may be used by computing device 700 to render graphics (e.g., 3D graphics). GPU(s) 708 may include many (e.g., tens, hundreds, or thousands) of cores that are capable of handling many software threads simultaneously. GPU(s) 708 may generate pixel data for output images in response to rendering commands (e.g., rendering commands from CPU(s) 706 received via a host interface). GPU(s) 708 may include graphics memory, such as display memory, for storing pixel data. The display memory may be included as part of memory 704. GPU(s) 708 may include two or more GPUs operating in parallel (e.g., via a link). When combined, each GPU 708 can generate pixel data for different portions of an output image or for different output images (e.g., a first GPU for a first image and a second GPU for a second image). Each GPU can include its own memory or can share memory with other GPUs.

In examples where the computing device 700 does not include the GPU(s) 708, the CPU(s) 706 may be used to render graphics.

Communication interface 710 may include one or more receivers, transmitters, and/or transceivers that enable computing device 700 to communicate with other computing devices via an electronic communication network, included wired and/or wireless communications. Communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet), low-power wide-area networks (e.g., LoRaWAN, SigFox, etc.), and/or the internet.

I/O ports 712 may enable the computing device 700 to be logically coupled to other devices including I/O components 714, presentation component(s) 718, and/or other components, some of which may be built in to (e.g., integrated in) computing device 700. Illustrative I/O components 714 include a microphone, mouse, keyboard, joystick, track pad, satellite dish, scanner, printer, wireless device, etc. I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of computing device 700. Computing device 700 may be include depth cameras, such as stereoscopic camera systems, infrared camera systems, RGB camera systems, touchscreen technology, and combinations of these, for gesture detection and recognition. Additionally, computing device 700 may include accelerometers or gyroscopes (e.g., as part of an inertia measurement unit (IMU)) that enable detection of motion. In some examples, the output of the accelerometers or gyroscopes may be used by computing device 700 to render immersive augmented reality or virtual reality.

Power supply 716 may include a hard-wired power supply, a battery power supply, or a combination thereof. Power supply 716 may provide power to computing device 700 to enable the components of computing device 700 to operate.

Presentation component(s) 718 may include a display (e.g., a monitor, a touch screen, a television screen, a heads-up-display (HUD), other display types, or a combination thereof), speakers, and/or other presentation components. Presentation component(s) 718 may receive data from other components (e.g., GPU(s) 708, CPU(s) 706, etc.), and output the data (e.g., as an image, video, sound, etc.).

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

### Additional Considerations

As used in this specification and appended claims, the singular forms “a”, “an”, and “the” include plural referents unless the content and context dictates otherwise. For example, reference to “a cell” includes a combination of two or more such cells. Unless indicated otherwise, an “or” conjunction is used in its correct sense as a Boolean logical operator, encompassing both the selection of features in the alternative (A or B, where the selection of A is mutually exclusive from B) and the selection of features in conjunction (A or B, where both A and B are selected).

It is to be understood that the phrases “for each <item> of the one or more <items>,” “each item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items. Similarly, the term “set” or “subset” should not be viewed, in itself, as necessarily encompassing a plurality of items-it will be understood that a set or a subset can encompass only one member or multiple members (unless the context indicates otherwise).

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

Various computational elements including processors, memory, instructions, routines, models, or other components may be described or claimed as “configured to” perform a task or tasks. In such contexts, the phrase “configured to” is used to connote structure by indicating that the component includes structure (e.g., stored instructions, circuitry, etc.) that performs the task or tasks during operation. As such, the unit/circuit/component can be said to be configured to perform the task even when the specified component is not necessarily currently operational (e.g., is not on).

The components used with the “configured to” language may refer to hardware-for example, circuits, memory storing program instructions executable to implement the operation, etc. Additionally, “configured to” can refer to generic structure (e.g., generic circuitry) that is manipulated by software and/or firmware (e.g., an FPGA or a general-purpose processor executing software) to operate in manner that is capable of performing the recited task(s). Additionally, “configured to” can refer to one or more memories or memory elements storing computer executable instructions for performing the recited task(s). Such memory elements may include memory on a computer chip having processing logic. In some contexts, “configured to” may also include adapting a manufacturing process (e.g., a semiconductor fabrication facility) to fabricate devices (e.g., integrated circuits) that are adapted to implement or perform one or more tasks.

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

1. A method for generating synthetic semiconductor image data, the method comprising:
generating a set of synthetic segmented images, each synthetic segmented image of the set of synthetic segmented images representing a segmented semiconductor metrology image;
generating, using a first trained GAN, a set of virtual images, each virtual image corresponding to one of the synthetic segmented images in the set of synthetic segmented images; and
constructing a training set comprising a plurality of training samples, each training sample comprising a synthetic segmented image from the set of synthetics segmented images and a corresponding virtual image from the set of virtual images, wherein the training set is usable to train a downstream model configured to model semiconductor fabrication processes.

2. The method of claim 1, wherein the set of synthetic segmented images are generated using a second trained GAN.

3. The method of claim 2, wherein the first trained GAN and the second trained GAN were trained concurrently.

4. The method of claim 3, wherein training the first trained GAN and the second trained GAN concurrently comprises updating weights associated with a first discriminator and a first generator associated with the first trained GAN based on a discriminator loss and/or a generator loss associated with a second discriminator and/or a second generator associated with the second trained GAN.

5. The method of claim 1, wherein generating the set of synthetic segmented images comprises generating each synthetic segmented image using a semiconductor process model.

6. The method of claim 5, wherein the semiconductor process model is a model configured to represent a particular semiconductor fabrication process.

7. The method of claim 6, wherein the particular semiconductor fabrication process is an etch process, and wherein the semiconductor process model generates image representing an etch profile as a result of the etch process given a set of process conditions provided as an input to the semiconductor process model.

8. The method of claim 5, further comprising applying a texture mapping deformation technique to at least one synthetic segmented image of the set of synthetic segmented images generated by the semiconductor process model, and wherein the at least one synthetic segmented image to which the texture mapping deformation technique is applied is included in the set of synthetic segmented images.

9. The method of claim 1, wherein generating the set of virtual images comprises:
generating, from a given synthetic segmented image of the set of synthetic segmented images, a corresponding gray scale image; and
providing the corresponding gray scale image to the first trained GAN.

10. The method of claim 9, wherein generating the corresponding gray scale image comprises applying a randomly generated color palette to the given synthetic segmented image.

11. The method of claim 1, wherein the segmented semiconductor metrology image corresponds to an electron microscopy (EM) image, scanning electron microscopy (SEM) image, a critical-dimension SEM image (CD-SEM), or a transmission electron microscopy (TEM) image.

12. The method of claim 1, wherein the downstream model trained using the training set is configured to label interfaces between materials in an input image having a same type as the segmented semiconductor metrology image.

13. The method of claim 1, wherein the downstream model trained using the training set is configured to provide dimension measurements of one or more wafer features included in an input image having a same type as the segmented semiconductor metrology image.

14. The method of claim 1, wherein the downstream model trained using the training set is configured to provide at least one measurement associated with an interface between materials in an input image having a same type as the segmented semiconductor metrology image.

15. The method of claim 1, wherein the first trained GAN utilizes a plurality of sets of discriminators and generators, each set of discriminator and generator corresponding to a different layer of a pyramidal structure, and each layer configured to utilize an image of a different size.

16. The method of claim 15, wherein each set of discriminator and generator of the plurality of sets of discriminators and generators are trained sequentially.

17. A computer program product comprising a non-transitory computer readable medium on which is provided computer executable instructions for causing a computational system to perform a method for generating synthetic semiconductor image data, the method comprising:
generating a set of synthetic segmented images, each synthetic segmented image of the set of synthetic segmented images representing a segmented semiconductor metrology image;
generating, using a first trained GAN, a set of virtual images, each virtual image corresponding to one of the synthetic segmented images in the set of synthetic segmented images; and
constructing a training set comprising a plurality of training samples, each training sample comprising a synthetic segmented image from the set of synthetics segmented images and a corresponding virtual image from the set of virtual images, wherein the training set is usable to train a downstream model configured to model semiconductor fabrication processes.

18. The computer program product of claim 17, wherein the set of synthetic segmented images are generated using a second trained GAN.

19. The computer program product of claim 18, wherein the first trained GAN and the second trained GAN were trained concurrently.

20. The computer program product of claim 19, wherein training the first trained GAN and the second trained GAN concurrently comprises updating weights associated with a first discriminator and a first generator associated with the first trained GAN based on a discriminator loss and/or a generator loss associated with a second discriminator and/or a second generator associated with the second trained GAN.

21. The computer program product of claim 17, wherein generating the set of synthetic segmented images comprises generating each synthetic segmented image using a semiconductor process model.

22. The computer program product of claim 21, wherein the semiconductor process model is a model configured to represent a particular semiconductor fabrication process.

23. The computer program product of claim 22, wherein the particular semiconductor fabrication process is an etch process, and wherein the semiconductor process model generates image representing an etch profile as a result of the etch process given a set of process conditions provided as an input to the semiconductor process model.

24. The computer program product of claim 21, wherein the method further comprises applying a texture mapping deformation technique to at least one synthetic segmented image of the set of synthetic segmented images generated by the semiconductor process model, and wherein the at least one synthetic segmented image to which the texture mapping deformation technique is applied is included in the set of synthetic segmented images.

25. The computer program product of claim 17, wherein generating the set of virtual images comprises:
generating, from a given synthetic segmented image of the set of synthetic segmented images, a corresponding gray scale image; and
providing the corresponding gray scale image to the first trained GAN.

26. The computer program product of claim 25, wherein generating the corresponding gray scale image comprises applying a randomly generated color palette to the given synthetic segmented image.

27. The computer program product of claim 17, wherein the segmented semiconductor metrology image corresponds to an electron microscopy (EM) image, scanning electron microscopy (SEM) image, a critical-dimension SEM image (CD-SEM), or a transmission electron microscopy (TEM) image.

28. The computer program product of claim 17, wherein the downstream model trained using the training set is configured to label interfaces between materials in an input image having a same type as the segmented semiconductor metrology image.

29. The computer program product of claim 17, wherein the downstream model trained using the training set is configured to provide dimension measurements of one or more wafer features included in an input image having a same type as the segmented semiconductor metrology image.

30. The computer program product of claim 17, wherein the downstream model trained using the training set is configured to provide at least one measurement associated with an interface between materials in an input image having a same type as the segmented semiconductor metrology image.

31.-32. (canceled)
